(19) United States
(12) Patent Application Publication
(10) Pub. No.: US 2007/0263668 A1
(43) Pub. Date: Nov. 15, 2007

(54) System, method and computer program for evaluating the audio quality of a received audio record

(76) Inventors: David Kam Wing Lau, Singapore (SG); Dennis Seow Hee Goh, Singapore (SG)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/432,747

(22) Filed: May 11, 2006

(51) Int. Cl. H04J 3/06

(52) U.S. Cl. 370/503; 370/252; 370/412

(57) ABSTRACT

In one embodiment, an audio record is received over a communication link and buffered. A data window is aligned with a portion of a buffer that contains the buffered audio record; and a portion of the buffered audio record to which the data window is aligned is compared with a portion of a reference audio record. If the portions of the buffered and reference audio records match, the records are synchronized in accord with a current position of the data window; and an audio quality of the buffered audio record is evaluated by comparing the synchronized audio records. If the portions of the buffered and reference audio records do not match, a location of the data window is incremented with respect to the buffer; and a comparison of A) the portion of the buffered audio record to which the data window is aligned, to B) the portion of the reference audio record, is repeated.

### BACKGROUND

At times, it is necessary to evaluate the voice quality of a communication link, such as a Voice over Internet Protocol (VoIP) communication link, or a cellular network communication link.

Traditionally, the voice quality of a communication link has been tested by establishing a call over the communication link, and then playing a reference speech record at a remote end of the communication link while recording a copy of the speech record at a local end of the communication link. The reference speech record is then played at the local end of the communication link, and a copy of the speech record is recorded at the remote end of the communication link. Finally, each of the recorded speech records is compared to the reference speech record to evaluate its voice quality; and the voice quality of one or both of the speech records is used to characterize the voice quality of the communication link.

Typically, synchronization between the local and remote ends of the communication link is required before each file play/record (FPR) process. Without synchronization, there is a high probability that either the beginning or the end of a speech record may not be recorded (e.g., because playback begins too early or ends too late, or because recording begins too early or ends too late). If part of a speech record is missed, or is recorded at the wrong time, comparison of the recorded speech record to a reference speech record will result in an erroneous indication of poor voice quality.

Of note, the time needed to synchronize the two ends of a communication link can add significant overhead to a voice quality test. This is especially so when synchronization is undertaken each time a speech record is played, and for each direction in which the speech record is played (which is typically the case).

### SUMMARY OF THE INVENTION

In one embodiment, a method comprises 1) buffering an audio record received over a communication link; 2) aligning a data window with a portion of a buffer that contains the buffered audio record; and 3) comparing a portion of the buffered audio record, to which the data window is aligned, with a portion of a reference audio record. If the portions of the buffered and reference audio records match, the buffered and reference audio records are synchronized in accord with a current position of the data window, and an audio quality of the buffered audio record is evaluated by comparing the synchronized audio records. If the portions of the buffered and reference audio records do not match, a location of the data window is incremented with respect to the buffer; and a comparison of A) the portion of the buffered audio record to which the data window is aligned, to B) the portion of the reference audio record, is repeated.

In another embodiment, a computer program comprises 1) code to initiate buffering of an audio record received over a communication link; 2) code to align a data window with a portion of a buffer that contains the buffered audio record; and 3) code to compare a portion of the buffered audio record, to which the data window is aligned, with a portion of a reference audio record. The computer program further comprises code to, if the portions of the buffered and reference audio records match, 1) synchronize the buffered and reference audio records in accord with a current position of the data window, and 2) evaluate an audio quality of the buffered audio record by comparing the synchronized audio records. The computer program also comprises code to, if the portions of the buffered and reference audio records do not match, 1) increment a location of the data window with respect to the buffer, and 2) repeat the comparison of A) the portion of the buffered audio record to which the data window is aligned, to B) the portion of the reference audio record.

In yet another embodiment, a system comprises an interface to receive and buffer an audio record. The audio record is received over a communication link to which the interface is attached. The system further comprises a processing system to 1) align a data window with a portion of a buffer that contains the buffered audio record, and 2) compare a portion of the buffered audio record, to which the data window is aligned, with a portion of a reference audio record. If the portions of the buffered and reference audio records match, the processing system 1) synchronizes the buffered and reference audio records in accord with a current position of the data window, and 2) evaluates an audio quality of the buffered audio record by comparing the synchronized audio records. If the portions of the buffered and reference audio records do not match, the processing system 1) increments a location of the data window with respect to the buffer, and 2) repeats the comparison of A) the portion of the buffered audio record to which the data window is aligned, to B) the portion of the reference audio record.

Other embodiments are also disclosed.

### BRIEF DESCRIPTION OF THE DRAWINGS

Illustrative embodiments of the invention are illustrated in the drawings, in which:

FIG. 1 illustrates an exemplary communication link;

FIG. 2 illustrates a first exemplary method for characterizing the audio quality of a communication link;

FIG. 3 illustrates a second exemplary method for characterizing the audio quality of a communication link;

FIG. 4 illustrates an exemplary implementation of a moving data window process employed by the method shown in FIG. 3;

FIGS. 5 & 6 illustrate exemplary movement of a data window with respect to a buffer; and

FIG. 7 illustrates an exemplary system for executing the method shown in FIG. 3.

### DETAILED DESCRIPTION

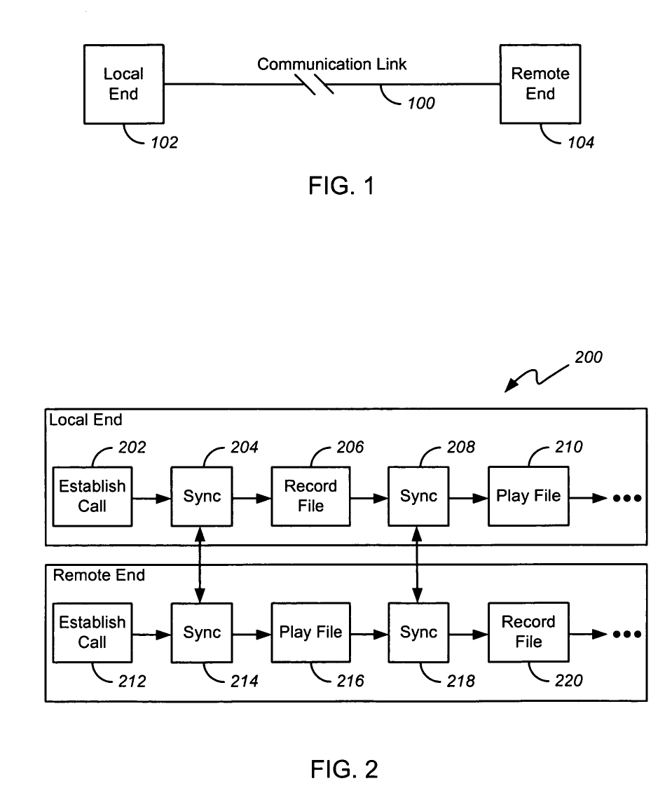

FIG. 1 illustrates an exemplary communication link 100, and FIG. 2 illustrates an exemplary method for characterizing the voice quality of the communication link 100. By way of example, the communication link 100 may be a Voice over Internet Protocol (VoIP) or cellular network communication link.

In accord with the method 200, the voice quality of the communication link 100 is characterized by first establishing a call between the local and remote ends 102, 104 of the communication link 100. See blocks 202 and 212 of FIG. 2. After the call is established, the local and remote ends 102, 104 of the communication link 100 are synchronized by, for example, sending test data or other synchronization information over the communication link. See blocks 204 and 214. Following synchronization, a reference speech file is played at one end of the communication link (block 216) and recorded at the other (block 206). The ends 102, 104 of the communication link 100 are then synchronized again (at blocks 208 and 218), and the file playback/record (FPR) process is repeated in the opposite direction (at blocks 210 and 220). By way of example, the method 200 shows the reference speech file being played first at the remote end 104 of the communication link 100, and then at the local end 102 of the communication link 100.

Finally, each of the speech files that is recorded during execution of the method 200 is compared to a corresponding reference speech file to evaluate its voice quality; and the voice quality of one or more individual speech files is used to characterize the voice quality of the communication link.

As previously mentioned, the synchronization steps 204, 208, 214, 218 of the method 200 can add significant overhead to a voice quality test. And, even if synchronization is successful, FPR timing can be jeopardized due to a network glitch.

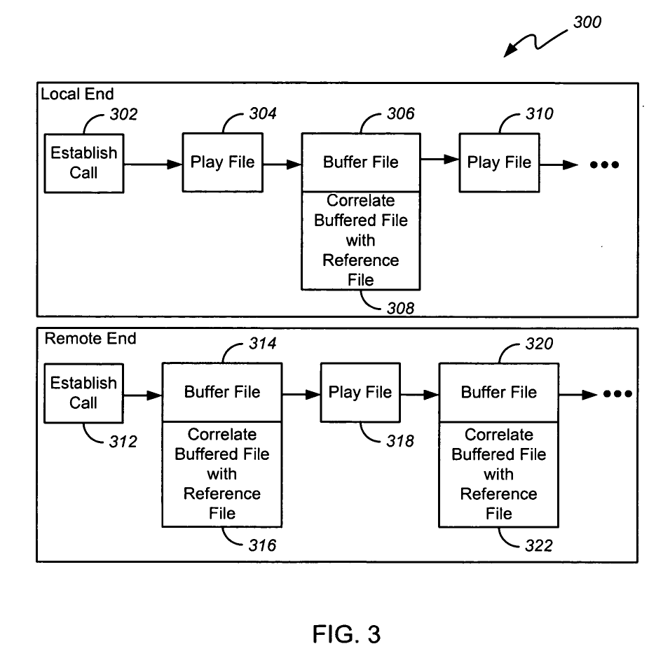

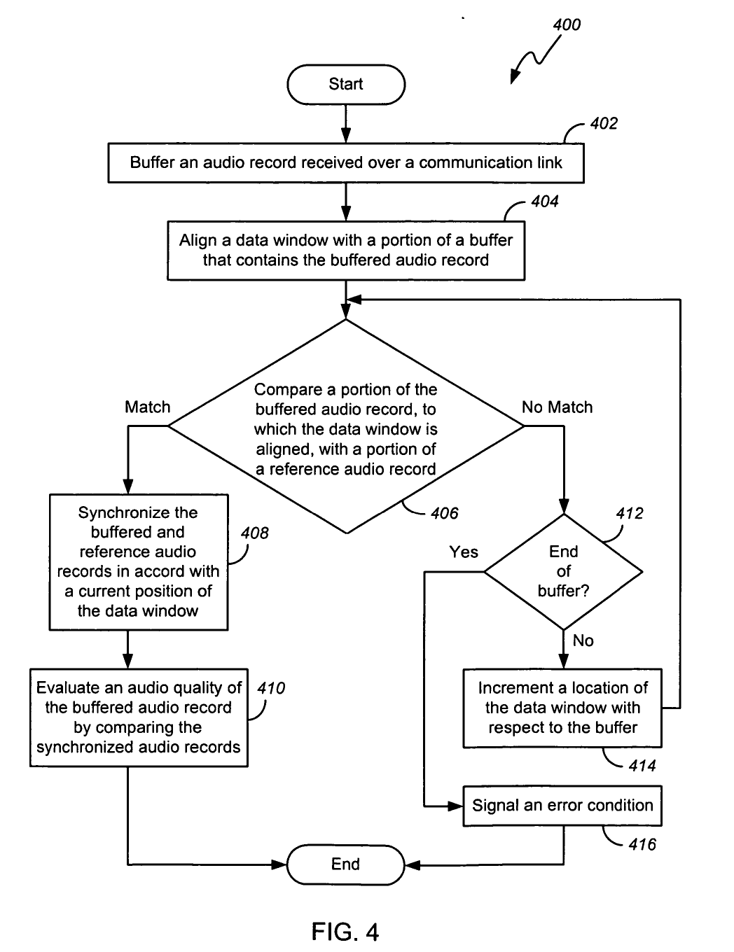

As an alternative to the method 200, FIG. 3 illustrates a new method 300 for characterizing the voice quality, or more generally, the “audio quality”, of the communication link 100. The method 300 begins with the establishment of a call. See blocks 302 and 312 of FIG. 3. However, in lieu of performing a synchronization operation, the method 300 proceeds directly to an FPR process, wherein a reference audio record (or speech record or file) is played at one end of the communication link (block 304) and buffered (e.g., recorded) at the other end (block 314). A correlation process is then undertaken using a moving “data window” (block 316). The correlation process may be undertaken during or after the FPR process. FIG. 4 illustrates an exemplary implementation of such a process.

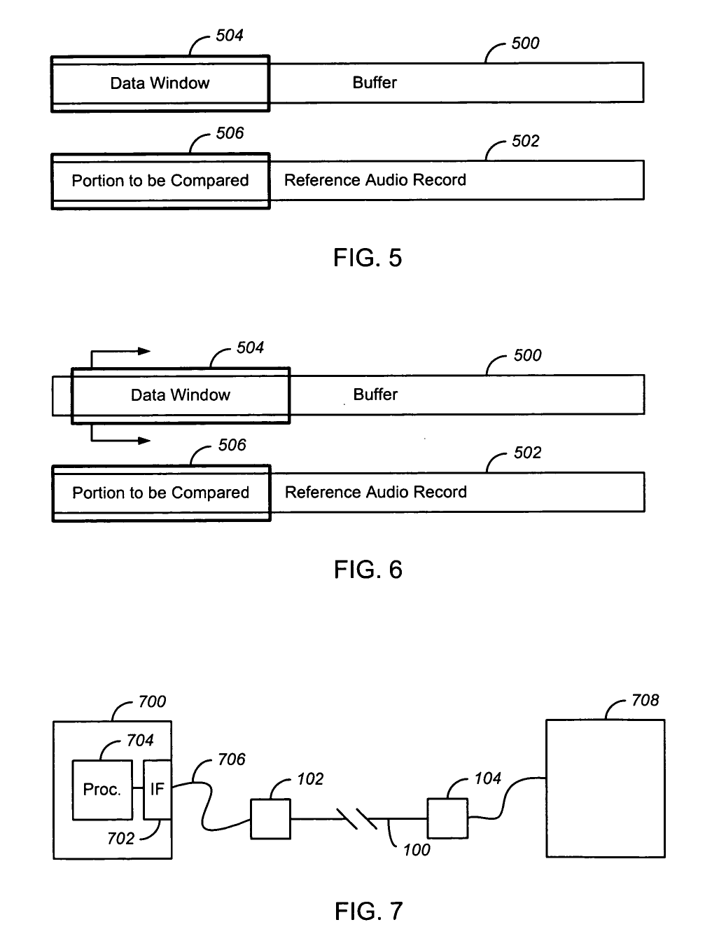

As shown in FIG. 4, an audio record that is played in accord with the method 300 may be received over a communication link and buffered at block 402. A data window may then be aligned with a portion of a buffer that contains the buffered audio record (block 404). Although the data window may be aligned with any portion of the buffer, it is preferable that the data window initially be aligned with the beginning of the buffer. See, for example, the exemplary buffer 500 and data window 504 shown in FIG. 5.

After aligning the data window 504 with a portion of the buffer 500, the portion of a buffered audio record to which the data window 504 is aligned is compared to a portion 506 of a reference audio record 502. See block 406 of FIG. 4; and FIG. 5. If the portions of the buffered and reference audio records match, then 1) the buffered and reference audio records are synchronized in accord with the current position of the data window 504 (at block 408), and 2) the audio quality of the buffered audio record is evaluated by comparing the synchronized audio records (at block 410). On the other hand, if the portions of the buffered and reference audio records do not match, then a location of the data window 504 is incremented with respect to the buffer 500. See block 414 of FIG. 4; and FIG. 6. The portion of the buffered audio record to which the data window 504 is aligned is then once again compared to the portion of the reference audio record (at block 406). The data window 504 then continues to move, and the method 400 is iterated until the portion of the buffered audio record that is aligned with the data window 504 matches the portion 506 of the reference audio record 502.

Upon incrementing the location of the data window 504 to the end of the buffer 500 (block 412), and upon failing to match any portion of the buffered audio record to the portion 506 of the reference audio record 502, an error condition may be signaled (at block 416).

In one embodiment of the method 400, it may be determined that the portions of the buffered and reference audio records match when the portions differ by no more than a difference threshold. By way of example, the difference threshold may specify a difference that may not be exceeded at any sample point in a audio record; or, the difference threshold may specify a cumulative sum of differences that may not be exceeded after analysis of a plurality of sample points in an audio record. In an alternate embodiment of the method 400, an exact match of the buffered and reference audio records may be required.

The lengths of the buffer 500 and data window 504 may vary. However, it is preferable that the buffer 500 be long enough (or that the data window 504 be short enough) to enable several movements of the data window 504 with respect to (and within the limits of) the buffer 500. The distance over which the data window 504 can be moved determines the sensitivity of the method 400 to variations in audio record timing.

It is also preferable that the data window 504 be moved in sufficiently small increments to enable a good correlation between buffered and reference audio records. In one exemplary embodiment, a buffer 500 was sized to store thirty seconds of recorded audio; a data window 504 was sized to span ten seconds of the buffer 500; and the data window 504 was moved with respect to the buffer 500 in increments of one-hundred (100) milliseconds (ms).

In one embodiment, the method 400 is commenced after buffering only part of an audio record. However, the method 400 may also be commenced after an audio record has been fully buffered.

Referring back to the method 300 (FIG. 3), in which actions performed at local and remote ends of a communication link are shown, one can see that, subsequent to establishing a call (at blocks 302 and 312), the local and remote ends of a communication link may alternate cycles of playing and buffering/correlating (at blocks 304, 306, 308, 310, 314, 316, 318, 320, 322). In this manner, audio records may be transmitted over a communication link in both directions, thereby enabling bidirectional evaluation of a communication link's audio quality.

If the buffers at each end of the communication link are sized slightly larger than the audio records that they are designed to buffer, then the play cycles 304, 310, 318 can be timed to occur somewhere within the “record windows” of the buffers (i.e., with playback 304 not beginning until after recording 314 has started, and with playback 304 ending before recording 314 has stopped).

In most cases, the method 400 will be executed by means of a computer program. In some cases, the computer program may be embodied in whole or in part in software or firmware. The computer program may be stored on any one or more computer-readable media, including, for example, any number or mixture of fixed or removable media (such as one or more fixed disks, random access memories (RAMs), read-only memories (ROMs), or compact discs), at either a single location or distributed over a network.

As shown in FIG. 7, the method 400 may be executed by means of a system 700. The system 700 may comprise an interface 702 having a buffer to receive and buffer an audio record that is received over a communication link 100 to which the interface 702 is attached. By way of example, the communication link 100 may be part of a telecommunications network such as a VoIP or cellular network. A similar or different system 708 may be coupled to an opposite end 104 of the communication link 100.

The system 700 may further comprise a processing system 704 to execute the method 400. In one embodiment, the processing system 700 includes a microprocessor 706, application-specific integrated circuit or field-programmable gate array (FPGA) that is controlled, at least in part, by software or firmware.

The system 700 may be housed within a single device, or may comprise multiple networked devices. In one embodiment, the system 700 is housed within an enclosure having a form-factor of a handheld device. The system 700 may be coupled directly to one end 102 of the communication link 100, or may be coupled to the end 102 via a cable 706 (e.g., a phone or network patch cable).

In addition to receiving one or more audio records via the interface 702, one or more audio records (i.e., reference audio records) may be transmitted over the communication link 100 via the interface 702. In this manner, the system 700 may facilitate execution of the method 400 at the opposite end 104 of the communication link 100, and may enable execution of the method 300 shown in FIG. 3.

What is claimed is:

1. A method, comprising:
buffering a audio record received over a communication link;
aligning a data window with a portion of a buffer that contains the buffered audio record;
comparing a portion of the buffered audio record, to which the data window is aligned, with a portion of a reference audio record;
if the portions of the buffered and reference audio records match, i) synchronizing the buffered and reference audio records in accord with a current position of the data window, and ii) evaluating an audio quality of the buffered audio record by comparing the synchronized audio records; and
if the portions of the buffered and reference audio records do not match, i) incrementing a location of the data window with respect to the buffer, and ii) repeating said comparison of A) the portion of the buffered audio record to which the data window is aligned, to B) the portion of the reference audio record.

2. The method of claim 1, further comprising, upon incrementing the location of the data window to an end of the buffer, and upon failing to match any portion of the buffered audio record to the portion of the reference audio record, signaling an error condition.

3. The method of claim 1, further comprising, determining that the portions of the buffered and reference audio records match when the portions differ by no more than a difference threshold.

4. The method of claim 1, further comprising, beginning said aligning and comparing after buffering only part of the audio record.

5. The method of claim 1, wherein:
the audio record is received after transmitting the audio record over the communication link in a first direction; and
the method further comprises, repeating the method after transmitting the audio record over the communication link in a second direction.

6. The method of claim 1, further comprising:
receiving multiple audio records over the communication link; and
repeating the method for each of the audio records received over the communication link.

7. The method of claim 1, wherein the communication link is a Voice over Internet Protocol (VoIP) communication link.

8. The method of claim 1, wherein the communication link is a cellular network communication link.

9. The method of claim 1, wherein the audio records are speech records.

10. The method of claim 9, wherein the audio quality is a voice quality.

11. A computer program, comprising:
code to initiate buffering of a audio record received over a communication link;
code to align a data window with a portion of a buffer that contains the buffered audio record;
code to compare a portion of the buffered audio record, to which the data window is aligned, with a portion of a reference audio record;
code to, if the portions of the buffered and reference audio records match, i) synchronize the buffered and reference audio records in accord with a current position of the data window, and ii) evaluate an audio quality of the buffered audio record by comparing the synchronized audio records; and
code to, if the portions of the buffered and reference audio records do not match, i) increment a location of the data window with respect to the buffer, and ii) repeat said comparison of A) the portion of the buffered audio record to which the data window is aligned, to B) the portion of the reference audio record.

12. A system, comprising:
an interface having a buffer, to receive and buffer a audio record received over a communication link to which the interface is attached;
a processing system to,
align a data window with a portion of the buffer, the buffer containing the buffered audio record;
compare a portion of the buffered audio record, to which the data window is aligned, with a portion of a reference audio record;
if the portions of the buffered and reference audio records match, i) synchronize the buffered and reference audio records in accord with a current position of the data window, and ii) evaluate an audio quality of the buffered audio record by comparing the synchronized audio records; and
if the portions of the buffered and reference audio records do not match, i) increment a location of the data window with respect to the buffer, and ii) repeat the comparison of A) the portion of the buffered audio record to which the data window is aligned, to B) the portion of the reference audio record.

13. The system of claim 12, further comprising an enclosure to house the interface and processing system, the enclosure having a form-factor of a handheld device.

14. The system of claim 12, wherein the processing system is controlled, at least in part, by software.

15. The system of claim 12, wherein the processing system is controlled, at least in part, by firmware.

16. The system of claim 12, wherein the interface is a telecommunications network interface.

17. The system of claim 12, wherein the processing system determines that the portions of the buffered and reference audio records match when the portions differ by no more than a difference threshold.

18. The system of claim 12, wherein the processing system begins said aligning and comparing after only part of the audio record is buffered by the interface.

19. The system of claim 12, wherein, before or after the audio record is received over the communication link, the processing system causes the reference audio record to be transmitted over the communication link via the interface.

20. The system of claim 12, wherein the processing system causes the interface to alternately receive and transmit a plurality of audio records over the communication link.

21. The system of claim 12, wherein the interface is configured for coupling to a Voice over Internet Protocol (VoIP) communication link.

22. The system of claim 12, wherein the interface is configured for coupling to a cellular network communication link.
